(19) United States
(12) Patent Application Publication
(10) Pub. No.: US 2014/0172626 A1
(43) Pub. Date: Jun. 19, 2014

(54) RECOMMENDATION-INFORMATION PROVIDING APPARATUS AND RECOMMENDATION-INFORMATION PROVIDING METHOD

(71) Applicant: Kabushiki Kaisha Toshiba, Tokyo (JP)

(72) Inventors: Takayoshi ITO, Yokohama-Shi (JP); Tetsuya KAISE, Tokyo (JP); Hideo KASAMI, Yokohama-Shi (JP)

(21) Appl. No.: 14/103,655

(22) Filed: Dec. 11, 2013

(30) Foreign Application Priority Data
Dec. 13, 2012 (JP) 2012-272692

(51) Int. Cl. G06Q 30/06

(52) U.S. Cl. CPC G06Q 30/0631
USPC 705/26.7

(57) ABSTRACT

A recommendation-information providing apparatus has an activity-history collecting part to collect activity histories of at least one of a first user and or a second user associated with the first user, a recommendation-information extracting part to extract recommendation information to be recommended to the first user, a recommendation-information providing part to provide the second user with the extracted recommendation information, a reservation accepting part to accept recommendation information for which the second user has performed a purchase reservation among the provided recommendation information, a purchase-intention confirming part to confirm a purchase intention of the first user by providing the first user with the accepted recommendation information, and a settlement processing part to perform a settlement process with the first user.

### CROSS REFERENCE TO RELATED APPLICATIONS

This application is based upon and claims the benefit of priority from the prior Japanese Patent Application No. 2012-272692, filed on Dec. 13, 2012, the entire contents of which are incorporated herein by reference.

### FIELD

Embodiments of the present invention relate to a recommendation-information providing apparatus and a recommendation-information providing method for providing recommendation information.

### BACKGROUND

When selling a commodity or service, it is general to directly send recommendation information to a person having a plan to buy the commodity or service. Recently, not with a communication means, such as direct mail and fax, examples of transmitting recommendation information via information media, such as electronic mail and SNS (Social Networking Service), have been rapidly increased.

However, when transmitting recommendation information via information media, such as electronic mail and SNS, there is a problem in that recommendation information cannot be sent to a would-be purchaser who is not familiar with information media. Therefore, a vendor of commodities or services has to know beforehand in what form it is better to send recommendation information to each would-be purchaser and then send recommendation information with a means suitable for each would-be purchaser. In this way, there is a problem in that it takes a lot of trouble to send the recommendation information.

### BRIEF DESCRIPTION OF THE DRAWINGS

FIG. 1 is a view schematically showing the configuration of a recommendation-information providing apparatus 1 according to a first embodiment;

FIG. 2 is a view schematically showing the configuration of a recommendation-information providing apparatus 1 according to a second embodiment;

FIG. 3 is a view schematically showing the configuration of a recommendation-information providing apparatus 1 according to a third embodiment;

FIG. 4 is a view schematically showing the configuration of a recommendation-information providing apparatus 1 according to a fourth embodiment; and

FIG. 5 is a view schematically showing the configuration of a recommendation-information providing apparatus 1 according to a fifth embodiment.

### DETAILED DESCRIPTION

According to one embodiment, a recommendation-information providing apparatus has an activity-history collecting part configured to collect activity histories of at least one of a first user and a second user associated with the first user, a recommendation-information extracting part configured to extract recommendation information to be recommended to the first user based on the activity histories collected by the activity-history collecting part, a recommendation-information providing part configured to provide the second user with the recommendation information extracted by the recommendation-information extracting part, a reservation accepting part configured to accept recommendation information for which the second user has performed a purchase reservation among recommendation information provided by the recommendation-information providing part, a purchase-intention confirming part configured to confirm a purchase intention of the first user by providing the first user with the recommendation information accepted by the reservation accepting part, and a settlement processing part configured to perform a settlement process with the first user when the first user shows a purchase intention.

Embodiments will now be explained with reference to the accompanying drawings.

### First Embodiment

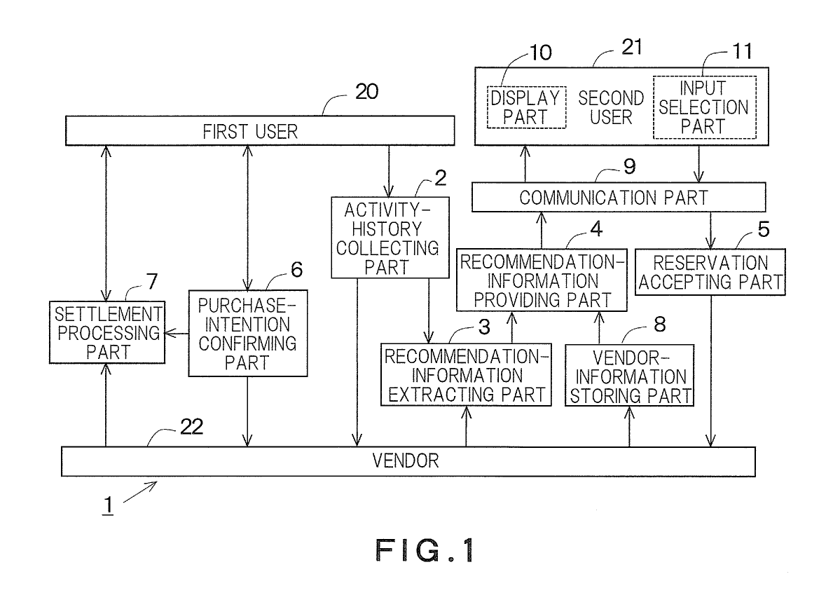

FIG. 1 is a block diagram schematically showing the configuration of a recommendation-information providing apparatus 1 according to a first embodiment. The recommendation-information providing apparatus 1 of FIG. 1 is provided with an activity-history collecting part 2, a recommendation-information extracting part 3, a recommendation-information providing part 4, a reservation accepting part 5, a purchase-intention confirming part 6, and a settlement processing part 7.

The activity-history collecting part 2 collects activity histories of a first user 20. The recommendation-information extracting part 3 extracts recommendation information to be recommended to the first user 20 based on the activity histories collected by the activity-history collecting part 2. The reservation accepting part 5 accepts the recommendation information for which a second user 21 associated with the first user 20 has made a purchase reservation, among recommendation information provided by the recommendation-information providing part 4. The purchase-intention confirming part 6 provides the first user 20 with the recommendation information accepted by the reservation accepting part 5 and confirms a purchase intention of the first user 20. When the first user 20 shows a purchase intention, the settlement processing part 7 performs a settlement process with the first user 20.

In addition to above, although not an essential component, the recommendation-information providing apparatus 1 of FIG. 1 is preferably provided with a vendor-information storing part 8 and a communicating part 9. The vendor-information storing part 8 stores information on a vendor 22 that provides recommendation information. The recommendation-information providing part 4 notifies a vendor that provides recommendation information extracted by the recommendation-information extracting part 3 to provide the first user 20 with the recommendation information based on the information stored in the vendor-information storing part 8. The communicating part 9 performs, for example, short-range wireless communication with a communication device owned by the second user 21 to provide recommendation information, receive a purchase reservation, etc. The communicating part 9 may perform communication with a communication device owned by the second user 21 with a communication means other than short-range wireless communication.

The second user 21 associated with the first user 20 is a person having some relation to the first user 20, such as a person related to the first user 20 by birth or a person acquainted with the first user 20.

In the present embodiment, recommendation information is not directly sent to the first user 20 who cannot handle information media well, such as an elderly person and a woman, but the second user 21 associated with the first user 20, such as a relative of the first user 20, is provided with recommendation information for the first user 20. Then, the second user 21 performs the procedure up to a purchase reservation for the recommendation information, and thereafter, the first user 20 is confirmed about a purchase intention. It is the first user 20 to perform a settlement process for a commodity or service related to the recommendation information.

The first user 20 is not limited to a person who cannot handle information media well, but includes, for example, a person who is too busy to use information media.

The information media indicate information provision via the Internet, an electronic mail, SNS, a portable information device such as a smart phone and a tablet terminal, etc. and digital information transmitted by a variety of communication means such as a kiosk terminal.

Recommendation information provided by the recommendation-information providing part 4 includes information on various paid commodities or services, but has no limitation on the kind of commodities or pay services. Services include, for example, an entrance fee, a member fee, and a reservation fee for various events.

To provide recommendation information includes Web advertising, electronic-mail advertising, electronic coupons, application software with advertisements, etc. provided via information media, but has no limitation on the actual providing means.

Activity histories collected by the activity-history collecting part 2 include, for example, purchase history information, search history information, transportation-use history information, medical information such as an outpatient history and medical history, residential area information, and TV viewing history information of the first user 20. Activity histories may also include member registration information and personal information on age, sex, an address, a family structure, etc. of the first user 20.

The activity-history collecting part 2 obtains, for example, information on when and where the first user 20 passed through an automatic ticket gate, as an activity history, from an IC card or the like that the first user 20 uses when passing through an automatic ticket gate. In this case, the activity-history collecting part 2 is installed in an automatic ticket gate or obtains information from an automatic ticket gate.

Moreover, the activity-history collecting part 2 may obtain medical information on the first user 20 as an activity history via an IC card owned by the first user 20 and issued by a specific medical institution.

As described above, various things are considered as actual contents of activity histories collected by the activity-history collecting part 2. It is presumed that the first user 20 is not familiar with information media. Therefore, it is desirable for the activity-history collecting part 2 to automatically collect activity histories of the first user 20 with no input operations or the like that is troublesome for the first user 20.

As one example, in the case where the first user 20 uses a member's card issued by a shop to buy a commodity at a shop, the activity-history collecting part 2 collects purchase information of the first user 20 as an activity history when the first user 20 shows the member's card and pays a bill at a cash register. The recommendation-information extracting part 3 looks up the purchase information collected by the activity-history collecting part 2 to grasp a purchase tendency from the purchase history of the first user 20 to extract recommendation information on, for example, a recommendable new product in which the first user 20 is considered to have an interest. In this embodiment, the extracted recommendation information is transmitted not to the first user 20 but to the second user 21. In this case, recommendation information is transmitted to a portable information device of the second user 21 in the form of mobile application, for example.

It is a precondition that the second user 21 knows very much about preference, a life style, etc. of the first user 20, so that, when new product information, that is considered to be a product the first user 20 is eager to get, is provided to the second user 21, the second user 21 makes a purchase reservation on behalf of the first user 20. A purchase reservation may be made through an electrical identification process using a portable information device such as an IC card owned by the second user 21.

When the second user 21 has made a purchase reservation, the reservation is notified to the vendor 22 that sells the reserved new product information, via the reservation accepting part 5. In more specifically, information on a purchase reservation is transmitted to a server or the like managed by the vendor 22, via the reservation accepting part 5.

The vendor 22 that has received the information on a purchase reservation from the second user 21 confirms a purchase intention of the first user 20 via the purchase-intention confirming part 6. It is a presumption that the first user 20 is not familiar with information media. Therefore, the vendor 22 confirms a purchase intention by means of a confirmation means the first user 20 is familiar with, such as a telephone, a mail, a direct visit, and a display on the screen of an interactive TV connected to the Internet. In this case, it is desirable that the second user 21 notifies the first user 20 that the second user 21 has made a purchase reservation for the first user 20. In this way, it is possible to call the first user 20's attention and relieve the anxiety of the first user 20 to purchase.

When a purchase intention of the first user 20 has been confirmed through a reply by telephone, a return mail, reception at a direct visit, a key operation on an interactive TV, etc., the vendor 22 performs a fare settlement process with the first user 20 via the settlement processing part 7, thereby establishing a contract for sale. If the first user 20 cannot perform an electrical settlement process, the first user 20 may perform a settlement process by payment through a financial institution, payment on delivery, confirmation of a credit card number by an operator, etc.

When a purchase intention cannot be confirmed by the purchase-intention confirming part 6 or the first user 20 rejects a fare settlement process with the settlement processing part 7, it is considered that a contact for sale of recommendation information has not been established. Then, it may be notified to the second user 21 that a purchase intention of the first user 20 could not have been confirmed or the first user 20 rejected a fare settlement process. And then when the second user 21 directly communicates with the first user 20 for a purchase reservation again, a purchase intention may be confirmed to the first user 20 and a settlement process may be performed with the first user 20.

The second user 21 receives provision of recommendation information from the recommendation-information providing part 4 via, for example, a portable information device such as a smartphone that performs short-range wireless communication with the recommendation-information providing apparatus 1 of FIG. 1. In this case, the timing to receive the provision is within the range of short-range Wireless communication with the recommendation-information providing apparatus 1 of FIG. 1. That is, for example, when the second user 21 has passed through an automatic ticket gate. The provided recommendation information is displayed on a display part 10 of a portable information device of the second user 21. The second user 21 views the recommendation information displayed on the display part 10 to make a purchase reservation for desired recommendation information, for example, by a touch screen operation. Information on the purchase reservation is acquired by an input selection part 11 installed in the portable information device and notified to the reservation accepting part 5 through, for example, short-range wireless communication.

There is no particular limitation on a concrete technique to notify the second user 21 of recommendation information and a concrete technique for the second user 21 to make a purchase reservation.

As described above, according to the first embodiment, recommendation information on a commodity or service the first user 20 seems to want to buy is extracted based on an activity history of the first user 20 and is provided to the second user 21 associated with the first user 20. When the second user 21 has made a purchase reservation for the provided recommendation information, a purchase intention is confirmed to the first user 20 and, if a purchase intention has been confirmed, a fare settlement process is performed with the first user 20. In this way, recommendation information can be exactly sent to the first user 20 who is not familiar with information media via the second user 21 who is familiar with information media. Therefore, the first user 20 can timely acquire recommendation information on a commodity or service the first user 20 is interested in, and can buy the commodity or service with no worries because the recommendation information is the one for which the reliable second user 21 has made a purchase reservation. Moreover, the vendor 22 can timely send various kinds of recommendation information to the first user 20 who is not familiar with information media via the second user 21. Therefore, the vendor 22 can increase sales of commodities or services without missing sales opportunity. Furthermore, since it is only needed for the vendor 22 to provide recommendation information via information media, there is no need to have an advertising means for customers who is not familiar with information media, so that an advertising cost can be reduced.

### Second Embodiment

The activity-history collecting part 2 of the first embodiment described above collects activity histories of the first user 20 whereas that of a second embodiment which will be described below collects activity histories of the second user 21.

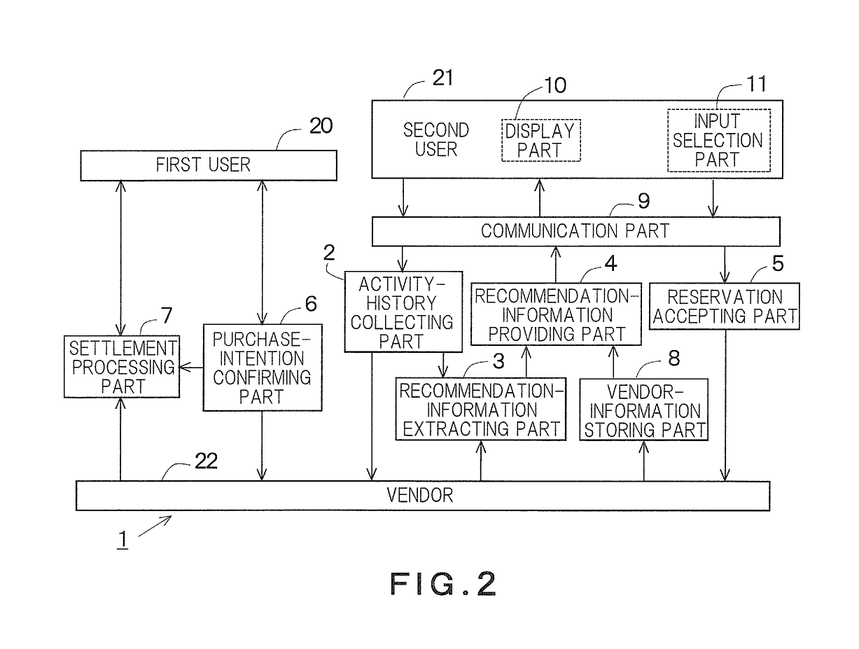

FIG. 2 is a block diagram schematically showing the configuration of a recommendation-information providing apparatus 1 according to the second embodiment. The recommendation-information providing apparatus 1 of FIG. 2 is different from FIG. 1 in that the activity-history collecting part 2 collects activity histories of the second user 21, but the other configuration is the same as FIG. 1.

For example, in the case where the first user 20 is a wife and the second user 21 is her husband, activity histories of the first user 20 can be predicted by collecting activity histories of the second user 21. Or in the case where the first user 20 is a parent and the second user 21 is his or her child, living together in the same house, having the same job, etc., activity histories of the first user 20 can also be predicted by collecting activity histories of the second user 21.

In such a situation, if the second user 21 is familiar with information media whereas the first user 20 is not and rarely goes out from his or her house, it is expected to be difficult to collect activity histories of the first user 20. Accordingly, the activity-history collecting part 2 in this embodiment predicts activity histories of the first user 20 from activity histories of the second user 21. Then, the recommendation-information extracting part 3 extracts recommendation information for the first user 20 based on activity histories of the second user 21 and provides the second user 21 with the extracted recommendation information via the recommendation-information providing part 4. The succeeding processes are the same as the first embodiment.

As described above, a feature of the second embodiment is not to directly collect activity histories of the first user 20 who has a plan to buy recommendation information but to collect activity histories of the second user 21 associated with the first user 20, thereby predicting activity histories of the first user 20. If the second user 21 is more familiar with information media than the first user 20, it is easier to collect activity histories of the second user 21 than activity histories of the first user 20. If the first user 20 and the second user 21 have a strong relevancy, activity histories of the first user 20 can be accurately predicted from activity histories of the second user 21. Therefore, based on the activity histories of the second user 21, the recommendation information that is most suitable for the first user 20 can be extracted.

In this embodiment, the stronger the relevancy between the first user 20 and the second user 21, the more accurately activity histories of the first user 20 can be predicted from activity histories of the second user 21.

As understood from the above first and second embodiments, the activity-history collecting part 2 collects activity histories of at least one of a first user and a second user associated with the first user.

### Third Embodiment

A third embodiment which will be described below is provided with a function to inspect the second user 21 to which recommendation information for the first user 20 is provided by identifying the relevancy between the first user 20 and the second user 21.

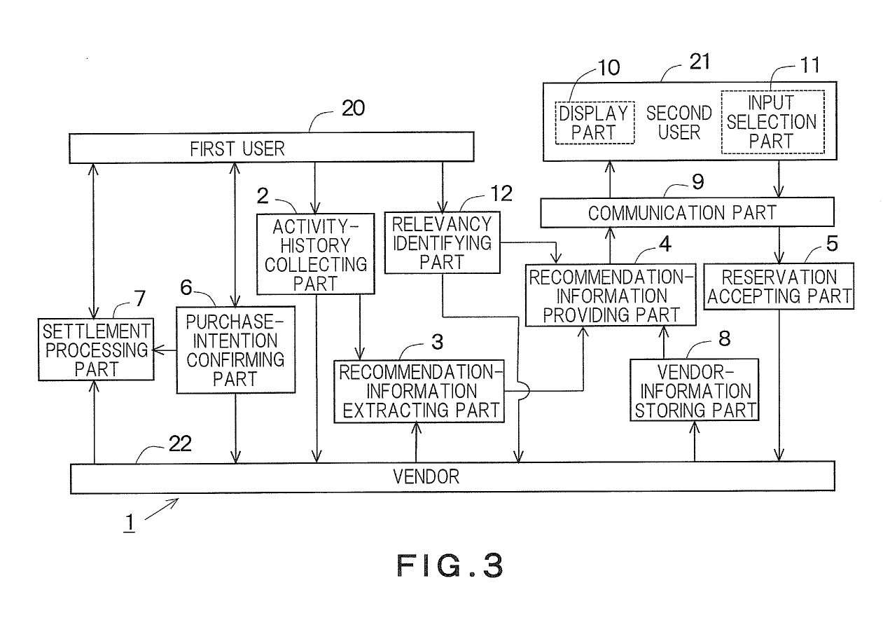

FIG. 3 is a block diagram schematically showing the configuration of a recommendation-information providing apparatus 1 according to the third embodiment. The recommendation-information providing apparatus 1 of FIG. 3 is provided with a relevancy identifying part 12 in addition to the configuration of FIG. 1.

The relevancy identifying part 12 identifies the relevancy between the first user 20 and the second user 21. For example, if there are a plurality of second users 21 to one first user 20, the relevancy identifying part 12 determines that a second user 21 having a deeper relevancy by birth with the first user 20 has a stronger relevancy with the first user 20. Specifically, it is considered that the relevancy is set weaker in order of a parent and a child, siblings, and relatives. Moreover, in the case where there are second users who have a relevancy by birth with the first user 20 and who does not have the relevancy, such as, blood relatives, lovers, friends, coworkers, and acquaintances, among a plurality of second users 21, it is considered that the relevancy is set weaker, for example, in order of blood relatives→lovers→friends→coworkers→acquaintances. These are just examples and the decision of relevancy can bet set freely.

In order to accurately identify the relevancy at the relevancy identifying part 12, it is needed to grasp the relevancy between the first user 20 and the second user 21 beforehand. Therefore, the first user 20 and the second user 21 may be asked to report their relevancy by themselves. Or the relevancy between the first user 20 and the second user 21 may be registered at a vendor server or the like beforehand, and by using the registered information, the relevancy between the first user 20 and the second user 21 may be automatically identified.

Based on the relevancy identified by the relevancy identifying part 12, the recommendation-information providing part 4 of FIG. 3 determines whether to provide the second user 21 with the recommendation information extracted by the recommendation-information extracting part 3.

As one example, a case is explained in which the first user 20 is a father and the second user 21 is his child, and the vendor 22 recommends a tour. In this case, although the first user 20 has much free time and surplus assets, the first user 20 cannot handle well information communication equipment such as a smartphone and a tablet terminal, and therefore has no chance of receiving recommendation information on a tour via information media such as an electronic mail and SNS. On the other hand, the second user 21 can easily handle information communication equipment, and therefore has a lot of chances of using information media. Since the first user 20 is a father and the second user 21 is his child, the relevancy identifying part 12 determines that there is a highly trustful relevancy between the first and second users 20 and 21. Then, the vendor 22 provides the second user 21 with recommendation information on a tour for the first user 20 via the recommendation-information providing part 4. When receiving the recommendation information, the second user 21 selects most suitable recommendation information and makes a purchase reservation on behalf of the first user 20. This purchase reservation is sent to the vendor 22 via the reservation accepting part 5. The vendor 22 confirms a purchase intention of the first user 20 via the purchase-intention confirming part 6. When the first user 20 really wants to buy, with acknowledging the second user 21's opinion according to need, the first user 20 performs a settlement process via the settlement processing part 7.

As described above, in the third embodiment, the relevancy identifying part 12 identifies the relevancy between the first user 20 and the second user 21, and the recommendation-information providing part 4 provides recommendation information for the first user 20 to the second user 21 who is suitable as a user to be provided with recommendation information for the first user 20. Therefore, it is possible to raise a probability that the first user 20 buys recommendation information.

Although in the third embodiment, the relevancy identifying part 12 is added to the recommendation-information providing apparatus 1 of FIG. 1, the relevancy identifying part 12 may be added to the recommendation-information providing apparatus 1 of FIG. 2.

### Fourth Embodiment

In a fourth embodiment which will be described below, it is determined whether to provide recommendation information based on a result of identification at the relevancy identifying part 12.

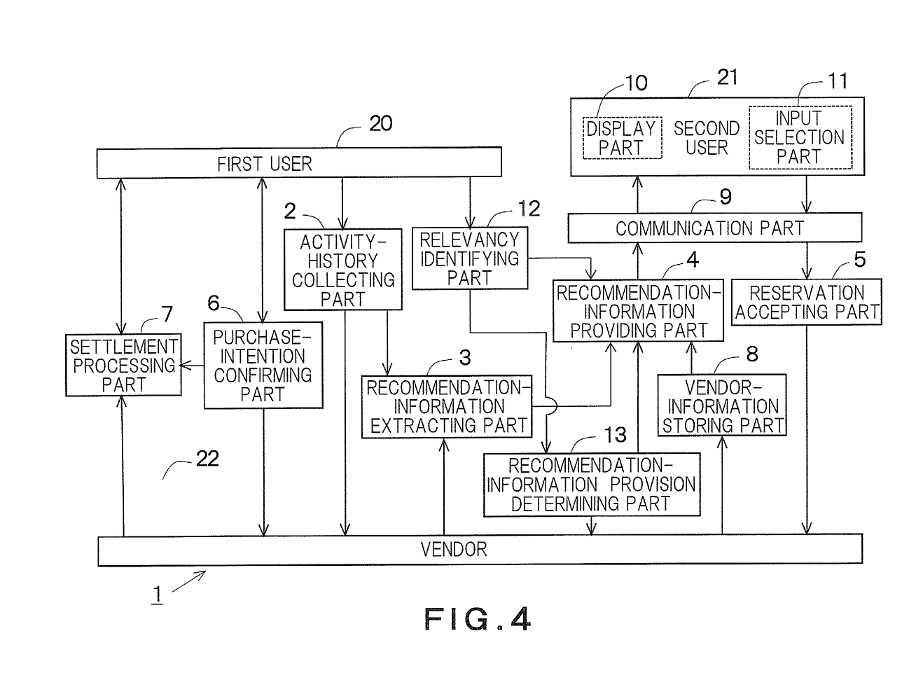

FIG. 4 is a block diagram schematically showing the configuration of a recommendation-information providing apparatus 1 according to the fourth embodiment. The recommendation-information providing apparatus 1 of FIG. 4 is provided with a recommendation-information provision determining part 13 in addition to the configuration of FIG. 3. Based on strength of the relevancy identified by the relevancy identifying part 12, the recommendation-information provision determining part 13 determines whether to provide the second user 21 with recommendation information extracted by the recommendation-information providing part 4.

If the first user 20 and the second user 21 are blood relatives, for example, within the third degree of relevancy by blood, the recommendation-information provision determining part 13 determines that the first and second users 20 and 21 have a strong relevancy to permit provision of recommendation information to the second user 21.

Depending on the kind of recommendation information, the recommendation-information provision determining part 13 may switch determination criteria on whether to provide the second user 21 with recommendation information. For example, for recommendation information on an expensive commodity or service exceeding a specific price, more strict determination criteria (for example, limited to a parent and a child) may be set. On the other hand, for recommendation information on a low-price commodity or service, the recommendation information may be provided to any second user 21 who is at least acquainted with the first user 20.

Moreover, depending on actual contents of a commodity or service, determination criteria of the recommendation-information provision determining part 13 may be switched. For example, when the first user 20 is a parent, for recommendation information on electric communication equipment, it is more likely that a son can more correctly determine the value of the recommendation information than a daughter, so that the recommendation information may be provided to the son only. On the contrary, for recommendation information on health care equipment, health food, etc., it is more likely that a daughter can more correctly determine the value of the recommendation information than a son, so that the recommendation information may be provided to the daughter only.

As described above, in the fourth embodiment, there is provided the recommendation-information provision determining part 13 that determines whether to provide recommendation information based on the strength of the relevancy between the first user 20 and the second user 21. Therefore, recommendation information can be provided only to the second user 21 who is considered by the first user 20 to correctly evaluate recommendation information. Then, the second user 21 can correctly determine whether to perform a purchase reservation. Accordingly, the first user 20 can buy, with no worries, a commodity or service related to the recommendation information for which the second user 21 has performed a purchase reservation.

In the fourth embodiment described above, the relevancy identifying part 12 and the recommendation-information provision determining part 13 are added to the recommendation-information providing apparatus 1 of FIG. 1. However, the relevancy identifying part 12 and the recommendation-information provision determining part 13 may be added to the recommendation-information providing apparatus 1 of FIG. 2.

### Fifth Embodiment

In a fifth embodiment which will be described below, if the first user 20 performs a settlement process after recommendation information is provided to the second user 21 and then the second user 21 performs a purchase reservation, a benefit is given to the second user 21.

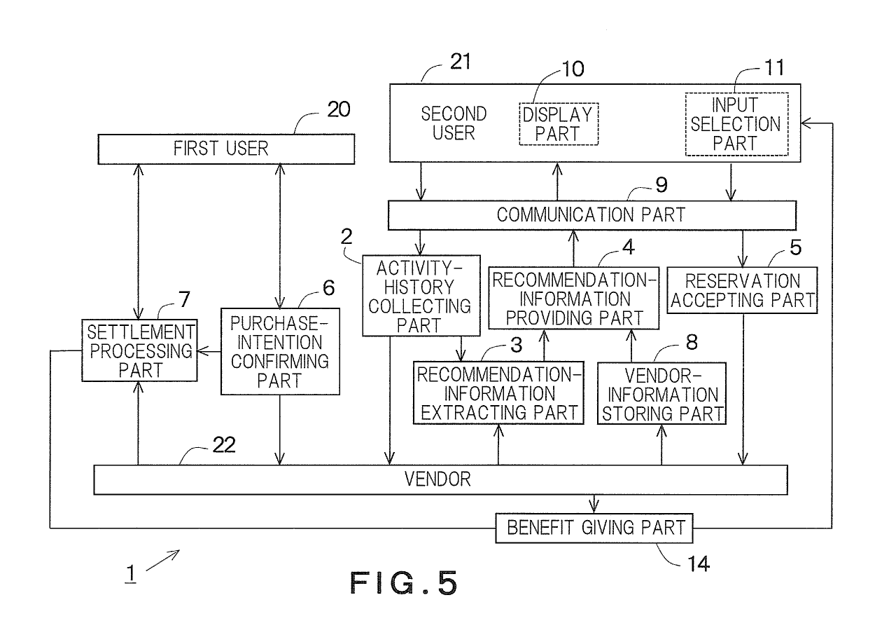

FIG. 5 is a block diagram schematically showing the configuration of a recommendation-information providing apparatus 1 according to the fifth embodiment. In addition to the configuration of FIG. 1, the recommendation-information providing apparatus 1 of FIG. 5 is provided with a benefit giving part 14. When the first user 20 buys recommendation information reserved by the second user 21, the benefit giving part 14 gives a benefit to the second user 21.

After recommendation information is provided to the second user 21 and then the second user 21 performs a purchase reservation, if the first user 20 completes a settlement process for buying a commodity or service in accordance with the recommendation information, the benefit giving part 14 gives a benefit to the second user 21 such as benefit points.

There is no limitation on the actual contents of a benefit. The benefit may depend on a purchase price.

A reason for giving a benefit not to the first user 20 but to the second user 21 is that, thanks to a purchase reservation by the second user 21, the first user 20 has shown an interest. An advantage to be expected is that the second user 21 examines the provided recommendation information more enthusiastically and performs a purchase reservation more actively to raise purchase eagerness of the first user 20.

As described above, in the fifth embodiment, a benefit is given to the second user 21 when the first user 20 performs a settlement process after recommendation information is provided to the second user 21 and then the second user 21 performs a purchase reservation. Therefore, the second user 21 examines recommendation information more enthusiastically and then performs a purchase reservation more actively, which can raise purchase eagerness of the first user 20. Accordingly, it is possible to increase the sales amount of commodities, services, etc.

In the fifth embodiment described above, the benefit giving part 14 is added to the recommendation-information providing apparatus 1 of FIG. 1. However, the benefit giving part 14 may be added to the recommendation-information providing apparatus 1 in any of FIGS. 2 to 4.

At least part of the recommendation-information providing apparatus 1 explained in the embodiments may be configured with hardware or software. When it is configured with software, a program that performs at least part of the functions of the recommendation-information providing apparatus 1 may be stored in a storage medium such as a flexible disk and CD-ROM, and then installed in a computer to run thereon. The storage medium may not be limited to a detachable one such as a magnetic disk and an optical disk but may be a standalone type such as a hard disk drive and a memory.

Moreover, a program that achieves the function of at least part of the recommendation-information providing apparatus 1 may be distributed via a communication network (including wireless communication) such as the Internet. The program may also be distributed via an online network such as the Internet or a wireless network, or stored in a storage medium and distributed under the condition that the program is encrypted, modulated or compressed.

The embodiment of the present invention is not limited to the respective embodiments described above but includes a variety of modifications conceivable by parsons skilled in the art. The advantages of the present invention are also not limited to those explained above. Accordingly, various addition, changes, and partial omissions may be made without departing from the scope and spirit of the inventions derived from the accompanying claims and their equivalents.

1. A recommendation-information providing apparatus comprising:
an activity-history collecting part configured to collect activity histories of at least one of a first user and a second user associated with the first user;
a recommendation-information extracting part configured to extract recommendation information to be recommended to the first user based on the activity histories collected by the activity-history collecting part;
a recommendation-information providing part configured to provide the second user with the recommendation information extracted by the recommendation-information extracting part;
a reservation accepting part configured to accept recommendation information for which the second user has performed a purchase reservation among the recommendation information provided by the recommendation-information providing part;
a purchase-intention confirming part configured to confirm a purchase intention of the first user by providing the first user with the recommendation information accepted by the reservation accepting part; and
a settlement processing part configured to perform a settlement process with the first user when the first user shows a purchase intention.

2. The apparatus of claim 1 further comprising a vendor-information storing part configured to store information on vendors that provide the recommendation information,
wherein, based on the information stored in the vendor-information storing part, the recommendation-information providing part notifies a vendor that provides recommendation information extracted by the recommendation-information extracting part to provide the first user with the recommendation information.

3. The apparatus of claim 1 further comprising a communicating part configured to perform short-range wireless communication with a communication device owned by the second user,
wherein, the recommendation-information providing part provides the communication device with recommendation information extracted by the recommendation-information extracting part, via the communicating part.

4. The apparatus of claim 3, wherein the recommendation-information providing part provides the communication device with data for displaying recommendation information extracted by the recommendation-information extracting part on a display part of the communication device, and
the reservation accepting part receives recommendation information selected by the second user from among recommendation information displayed on the display part of the communication device, via the communicating part, and accepts a purchase reservation.

5. The apparatus of claim 1 further comprising a relevancy identifying part configured to identify a relevancy between the first user and the second user,
wherein the recommendation-information providing part determines whether to provide the second user with recommendation information extracted by the recommendation-information extracting part, based on a relevancy identified by the relevancy identifying part.

6. The apparatus of claim 5 further comprising a recommendation-information provision determining part configured to determine whether to provide the second user with recommendation information extracted by the recommendation-information extracting part, based on strength of a relevancy identified by the relevancy identifying part,
wherein the recommendation-information providing part provides the second user determined to be provided by the recommendation-information provision determining part with recommendation information extracted by the recommendation-information extracting part.

7. The apparatus of claim 5, wherein the relevancy identifying part identifies a relevancy between the first user and the second user based on the contents reported by the second user on a relevancy with the first user.

8. The apparatus of claim 5, wherein the relevancy identifying part identifies the relevancy based on a relevancy by blood between the first user and the second user.

9. The apparatus of claim 1 further comprising a benefit giving part configured to give the second user a benefit when the first user has bought recommendation information reserved by the second user.

10. The apparatus of claim 1, wherein the activity-history collecting part collects the activity histories of the first user based on a communication history with a portable information device held by the first user.

11. A recommendation-information providing method comprising:
collecting activity histories of at least one of a first user and a second user associated with the first user;
extracting recommendation information to be recommended to the first user, based on the collected activity histories;
providing the second user with the extracted recommendation information;
accepting recommendation information reserved by the second user among the provided recommendation information;
providing the first user with the accepted recommendation information to confirm a purchase intention of the first user; and
performing a settlement process with the first user when the first user shows a purchase intention.

12. The method of claim 11 further comprising:
storing information on vendors that provide the recommendation information,
wherein, based on the stored information, a vendor that provides the extracted recommendation information is notified to provide the first user with the recommendation information.

13. The method of claim 11 further comprising:
performing short-range wireless communication with a communication device owned by the second user,
wherein, the communication device is provided with the extracted recommendation information, by the short-range wireless communication.

14. The method of claim 13, wherein the communication device is provided with data for displaying the extracted recommendation information on a display part of the communication device, and
recommendation information selected by the second user from among recommendation information displayed on the display part of the communication device is received by the short-range wireless communication to accept a purchase reservation.

15. The method of claim 11 further comprising:
identifying a relevancy between the first user and the second user,
wherein it is determined whether to provide the second user with the extracted recommendation information, based on the identified relevancy.

16. The method of claim 15 further comprising:
determining whether to provide the second user with the extracted recommendation information, based on strength of the identified relevancy,
wherein the second user determined to be provided is provided with the extracted recommendation information.

17. The method of claim 15, wherein a relevancy between the first user and the second user is identified based on the contents reported by the second user on a relevancy with the first user.

18. The method of claim 15, wherein the relevancy is identified based on a relevancy by blood between the first user and the second user.

19. The method of claim 11 further comprising:
giving the second user a benefit when the first user has bought recommendation information reserved by the second user.

20. The method of claim 11, wherein the activity-history collecting part collects the activity histories of the first user based on a communication history with a portable information device held by the first user.
